(19) United States
(12) Patent Application Publication
(10) Pub. No.: US 2025/0306208 A1
(43) Pub. Date: Oct. 2, 2025

(54) LASER SLAM SYSTEM FOR SLOPE COMPENSATION BY USING IMU AND IMPLEMENTATION METHOD THEREOF

(71) Applicant: SINOSTEEL MAANSHAN GENERAL INSTITUTE OF MINING RESEARCH CO., LTD, Ma'anshan (CN)

(72) Inventors: Wen NIE, Ma'anshan (CN); Bibo DAI, Ma'anshan (CN); Liangliang QIAN, Ma'anshan (CN); Xuemin ZENG, Ma'anshan (CN); Yunmin WANG, Ma'anshan (CN); Tianqiang ZHU, Ma'anshan (CN)

(21) Appl. No.: 18/970,094

(22) Filed: Dec. 5, 2024

(30) Foreign Application Priority Data
Mar. 29, 2024 (CN) 202410376288.6

(51) Int. Cl. G01S 17/86; G01S 7/48; G01S 17/42; G01S 17/894; G06T 7/73

(52) U.S. Cl. CPC G01S 17/86; G01S 7/4808; G01S 17/42; G01S 17/894; G06T 7/74; G06T 2207/10028

(57) ABSTRACT

A laser SLAM system for slope compensation by using IMU and an implementation method thereof are provided. The system includes: a data preprocessing and slope detection module for acquiring and processing original point cloud data in a roadway to obtain slope information; acquiring and processing IMU data of a mobile vehicle to obtain initial values of a position and posture of the mobile vehicle and the IMU factors; a laser point cloud position and posture estimation module for classifying feature points based on the slope information and the initial values of the position and posture of the mobile vehicle to obtain a joint error; performing inter-frame matching position and posture estimation and obtaining key frame factors; and a high-precision mapping module for optimizing a factor map, and obtaining a global map of a ramp to complete the slope compensation.

### CROSS-REFERENCE TO RELATED APPLICATIONS

This application claims priority to Chinese Patent Application No. 202410376288.6, filed on Mar. 29, 2024, the contents of which are hereby incorporated by reference.

### TECHNICAL FIELD

The disclosure belongs to the technical field of positioning and mapping of mobile robots, and particularly relates to a laser SLAM (Simultaneous Localization and Mapping) system for slope compensation by using IMU (Inertial Measurement Unit) and an implementation method thereof.

### BACKGROUND

Nowadays, the SLAM technology of mobile robots has been widely studied. SLAM technology is not only widely used in autonomous mobile robots and autonomous driving, but also plays an important role in special fields such as underground mines, tunnels and coal mine roadways. Complex environment, such as the lack of surface characteristics of mine rock wall, dark environment and irregular environment such as bumpy and slippery road surface, often poses great challenges to navigation and motion control system. Especially, the ground fluctuates greatly, and there are many uphill and downhill or multi-layer environments, and the posture of vehicles often changes sharply due to the changes of road conditions. However, traditional navigation systems are mostly based on plane assumptions, so it is difficult to accurately track and correct these posture changes, which leads to the accumulation of positioning errors and posture drift. At the same time, the autonomous mobile robot may not judge the passability of the slope, which not only affects the accuracy of vehicle positioning and mapping, but also may affect the safety of navigation decision.

In some mine roadways, the internal road surface is complex, the slope is large and uneven, and the movement of the robot is greatly affected by the pitching and bouncing movement, resulting in a great posture change. Slope detection is helpful to build a more realistic map and improve the positioning accuracy, which is of great significance to special scenes such as underground mines. Laser SLAM frames, such as LOAM, Cartomaper and GMapping, have obvious structural characteristics, especially in indoor conditions. However, the plane-assumed motion model may not correctly describe the actual motion under the slope condition, and the cloud reading is large when going uphill, the number of feature points is reduced, and the deviation of kinematic assumptions is increased. When going downhill, the point clouds in the occlusion area are dense and repetitive, which leads to the difficulty of feature matching and the increase of positioning drift. ZHANG J and others put forward a lightweight laser mileage calculation method, LeGO-LOAM, which is based on ground optimization, and the motion efficiency is high and ground point reference is extracted, but it is difficult to compensate motion distortion at non-uniform speed, and position and posture estimation is easy to diverge in large scenes. Carpenter and others proposed particle filter (PF) through extended Kalman filter. This method is based on Bayesian filtering framework and adopts Monte Carlo importance sampling to adapt to the nonlinear problems in SLAM. Compared with the assumption that Kalman filter only depends on linear Gaussian, particle filter increases the ability to deal with nonlinear and non-Gaussian noise, and may effectively deal with nonlinear problems caused by robot motion and sensor measurement. Tixiao Shan et al. proposed LIO-SAM based on the map optimization of laser and inertia, and then added visual information to it, and proposed LVI-SAM. Jia et al. proposed a tightly coupled multi-sensor fusion framework Lvio-Fusion. Most of the research is to fuse IMU as a data source with other sensors to improve the reliability of state estimation, neglecting to actively analyze the slope information provided by IMU to correct the motion drift in the slope environment. Therefore, it is necessary to establish a more reasonable nonlinear model, increase the positioning constraints, effectively analyze and utilize IMU information, and realize active compensation through algorithmic means, so as to make the SLAM system adapt to the complex environment.

### SUMMARY

Aiming at the shortcomings of the prior art, the disclosure provides a laser SLAM system for slope compensation by using IMU and an implementation method thereof. A new observation model is constructed according to IMU data, and posture data is integrated into a map optimization framework for constraint, thus realizing active compensation for SLAM algorithm. This method may not only improve the accuracy of positioning and mapping, but also enable the robot to judge the terrain passability and avoid making dangerous decisions in complex environment. Generally speaking, the scheme combines point cloud processing and map optimization, and makes SLAM system adapt to various complex environments and landforms by using the active analysis and correction of IMU information.

In order to achieve the above objectives, the present disclosure provides the following scheme.

A laser SLAM system for slope compensation by using IMU, including:
a data preprocessing and slope detection module, used for acquiring and processing original point cloud data in a roadway to obtain slope information; acquiring and processing IMU data of a mobile vehicle to obtain initial values of a position and posture of the mobile vehicle and the IMU factors;
a laser point cloud position and posture estimation module, used for classifying feature points based on the slope information and the initial values of the position and posture of the mobile vehicle to obtain a joint error; performing an inter-frame matching position and posture estimation and obtaining key frame factors; and
a high-precision mapping module, used for optimizing a factor map based on the joint error, the inter-frame matching position and posture estimation, the key frame factors and the IMU factors, and obtaining a global map of a ramp based on a local map of the ramp to complete the slope compensation.

Optionally, the data preprocessing and slope detection module comprises:
a point cloud data processing unit, used for acquiring the original point cloud data in the roadway and filtering the original point cloud data to obtain point cloud information of the ramp; segmenting and fitting the point cloud information of the ramp by adopting a random sampling consistent algorithm to obtain the slope information; and
an IMU data processing unit, used for acquiring the IMU data of the mobile vehicle, and performing IMU pre-integration based on the point cloud information of the ramp to obtain the initial values of the position and posture of the mobile vehicle.

Optionally, the point cloud data processing unit comprises:
a point cloud data acquiring subunit, used for acquiring the original point cloud data in the roadway;
a filtering subunit, used for filtering out outliers in the original point cloud data in the roadway based on a statistical filter to obtain point clouds only comprising roadway four walls and ground; based on a straight-through filter, point cloud of the roadway four walls in the point cloud comprising the roadway four walls and the ground are filtered to obtain slope point cloud with a preset contour; filtering the slope point cloud based on a dynamic voxel filter to obtain the point cloud information of the ramp; where the point cloud information of the ramp comprises ground point clouds and slope point clouds; and
a slope detection subunit, used for segmenting and fitting the slope point cloud in the slope point cloud information based on RANSAC random sampling consistency algorithm to obtain the slope information.

Optionally, a specific process for the slope detection subunit to obtain the slope information is as follows:
acquiring a parameter set to be estimated based on a preset loss function, a threshold constant and an error function of a set distance;
fitting the parameter set to be estimated to obtain optimal parameters, and constructing a slope point cloud fitting model; and
obtaining the slope information based on the slope point cloud fitting model.

Optionally, the IMU data processing unit comprises:
an IMU data acquiring subunit, used for obtaining a pitch angle and a roll angle of the mobile vehicle in a navigation coordinate system based on a three-axis gyroscope and a three-axis accelerometer fixed on the mobile vehicle;
an IMU data processing subunit, used for converting the pitch angle and the roll angle into a directional cosine matrix and establishing an IMU pre-integration observation model; and
a distortion correction subunit, used for carrying out distortion correction on the original point cloud data in the roadway based on the IMU pre-integration observation model, and dividing angular points and surface points by using local smoothness evaluation variables to obtain the initial values of the position and posture of the mobile vehicle.

Optionally, the laser point cloud position and posture estimation module comprises:
a feature point classification unit, used for comparing the point clouds before and after a straight-through filtering to obtain a slope point cloud, and combining angle information of the pitch angle and the roll angle to classify the feature points;
a joint error construction subunit, used for adding a slope constraint to the mobile vehicle, and obtaining the joint error based on the feature points and joint map optimization of submaps; and
an inter-frame matching position and posture estimation subunit, used for performing inter-frame matching position and posture estimation based on the slope information and the initial values of the position and posture of the mobile vehicle to obtain the key frame factors.

Optionally, the feature points comprise ground points, slope points and wall points.

The disclosure also provides an implementation method of laser SLAM system for slope compensation by using IMU, comprising following steps:
acquiring and processing original point cloud data in a roadway to obtain slope information; acquiring and processing IMU data of a mobile vehicle to obtain initial values of a position and posture of the mobile vehicle and the IMU factors;
classifying feature points based on the slope information and the initial values of the position and posture of the mobile vehicle to obtain a joint error; performing an inter-frame matching position and posture estimation and obtaining key frame factors; and
optimizing a factor map based on the joint error, the inter-frame matching position and posture estimation, the key frame factors and the IMU factors, and obtaining a global map of a ramp based on a local map of the ramp to complete the slope compensation.

Compared with the prior art, the disclosure has the beneficial effects that the laser SLAM system based on IMU slope compensation may obviously improve the positioning and mapping accuracy of the mobile robot in a complex environment. According to the point cloud data collected in the roadway, the slope model may be fitted and the slope may be detected, which provides prior information for position and posture estimation. Compared with the traditional technique of simply fusing IMU as a sub-sensor, this method may actively analyze IMU information, and may effectively compensate the pose after adding multi-factor map optimization, thus enhancing the adaptability to complex terrain. The specific effect is shown in FIG. 4. Considering the slope constraint, the positioning error of mobile robot may be reduced by 20%, at the same time, the error rate of point cloud registration may be reduced, and the convergence speed of EKF and other filters may be improved, which is obviously helpful for small robots to make traffic decisions and make them build more complete and detailed maps. This technology has a wide range of applications, and may be extended to a variety of mobile platforms such as unmanned vehicles, unmanned aerial vehicles and underwater vehicles for SLAM in complex environments.

### BRIEF DESCRIPTION OF THE DRAWINGS

In order to explain the technical scheme of the present disclosure more clearly, the drawings needed in the embodiments are briefly introduced below. Obviously, the drawings in the following description are only some embodiments of the present disclosure. For ordinary people in the field, other drawings may be obtained according to these drawings without paying creative labor.

FIG. 1 is a schematic structural diagram of a laser SLAM system for slope compensation by using IMU in an embodiment of the present disclosure.

FIG. 2 is an internal frame diagram of a laser SLAM system for slope compensation by using IMU in an embodiment of the present disclosure.

FIG. 3 is a flow chart of slope identification based on Lidar point cloud in the embodiment of the present disclosure

FIG. 4 is a schematic diagram of multi-factor joint map optimization with slope constraint in the embodiment of the present disclosure.

### DETAILED DESCRIPTION OF THE EMBODIMENTS

In the following, the technical scheme in the embodiment of the disclosure will be clearly and completely described with reference to the attached drawings. Obviously, the described embodiment is only a part of the embodiment of the disclosure, but not the whole embodiment. Based on the embodiments in the present disclosure, all other embodiments obtained by ordinary technicians in the field without creative labor belong to the scope of protection of the present disclosure.

In order to make the above objects, features and advantages of the present disclosure more obvious and easy to understand, the present disclosure will be further described in detail with the attached drawings and specific embodiments.

### Embodiment 1

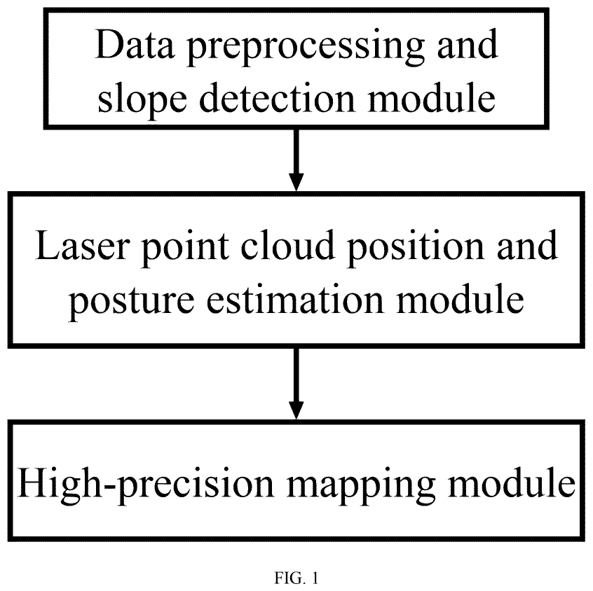

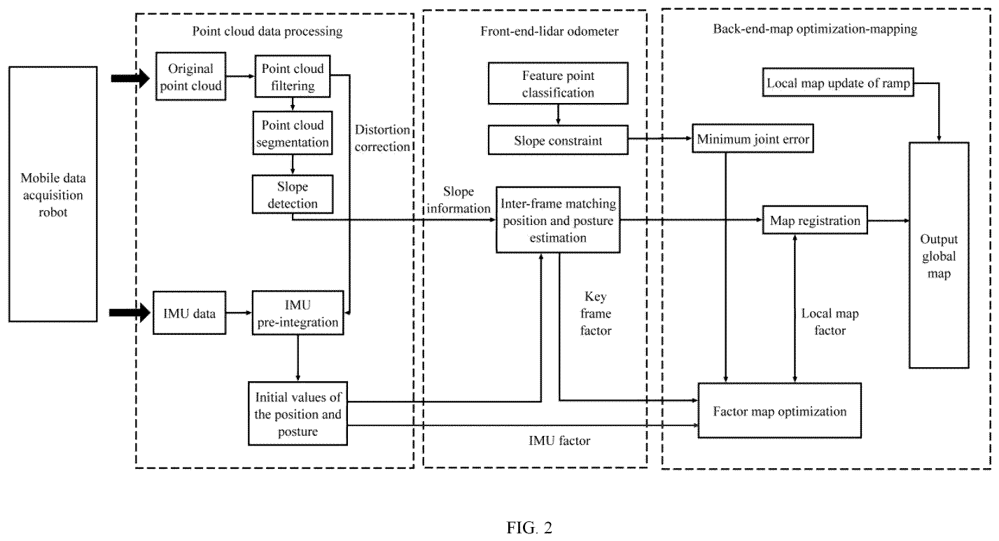

In view of the drastic change of robot posture caused by the large terrain fluctuation in underground mine environment, which seriously affects the positioning and mapping accuracy of SLAM algorithm based on plane assumption. However, in the prior art, the IMU is only used as the data source of the sub-sensor for simple fusion, and the active compensation for this posture change cannot be realized. In addition, in the dark underground roadway, the robot may not accurately judge the ground slope information, and the navigation decision may face security risks. Aiming at the complex roadway with large fluctuation, the disclosure proposes a laser SLAM system for slope compensation by using IMU, so as to compensate according to the slope data. As shown in FIG. 1 and FIG. 2, the system comprises a data preprocessing and slope detection module, a laser point cloud position and posture estimation module (front-end laser radar odometer) and a high-precision mapping module (back-end factor map optimization).

The mobile robot (mobile vehicle) is equipped with multi-line lidar and IMU, and outputs the final global map through point cloud data processing, front-end lidar odometer and back-end factor map optimization. Because the IMU directly shows the pitch angle data of the mobile robot at the instantaneous moment, not the angle data of the slope, if the slope angle information may be added, the ground points, the slope points and the roadway wall points may be separated according to the angle information. The slope detection unit is added after the point cloud filtering, which may provide prior information for the robot position and posture transformation, reduce the error caused by feature matching, and may also add corresponding slope constraints to the laser odometer. The multi-factor map is optimized to output the global map. According to the climbing ability of different mobile vehicles, the ramps that the cars may not pass are marked in the corresponding map, and the ramps with little influence are marked in the three-dimensional map, which provides necessary information for the decision-making and movement of the robot.

Specifically, the data preprocessing and slope detection module is used for acquiring and processing the original point cloud data in the roadway to obtain slope information; acquiring and processing IMU data of the mobile vehicle to obtain the initial values of the position and posture of the mobile vehicle and the IMU factor; the IMU factors refer to the data obtained by IMU (inertial measurement unit), such as tilt and rotation information, as a constraint, which is added to the back-end factor map optimization, and combined with lidar data to improve the positioning and mapping accuracy.

As a further embodiment, the data preprocessing and slope detection module comprises:
a point cloud data processing unit, used for acquiring the original point cloud data in the roadway and filtering the original point cloud data to obtain point cloud information of the ramp; segmenting and fitting the point cloud information of the ramp by adopting a random sampling consistent algorithm to obtain the slope information; and
an IMU data processing unit, used for acquiring the IMU data of the mobile vehicle, and performing IMU pre-integration based on the point cloud information of the ramp to obtain the initial values of the position and posture of the mobile vehicle.

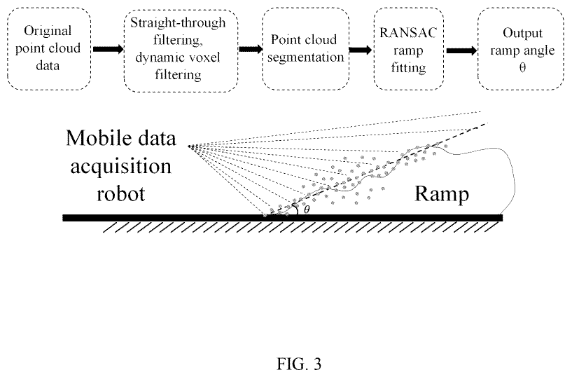

As shown in FIG. 3, a further embodiment is that the point cloud data processing unit comprises:
a point cloud data acquiring subunit, used for acquiring the original point cloud data in the roadway;
a filtering subunit, used for filtering out outliers in the original point cloud data in the roadway based on a statistical filter to obtain point clouds only comprising roadway four walls and ground; based on a straight-through filter, point cloud of the roadway four walls in the point cloud comprising the roadway four walls and the ground are filtered to obtain slope point cloud with a preset contour; filtering the slope point cloud based on a dynamic voxel filter to obtain the point cloud information of the ramp; where the point cloud information of the ramp comprises ground point clouds and slope point clouds.

In this embodiment, in view of the partial noise existing in the original point cloud data Pi inside the roadway, statistical filter may be used to filter out outliers to obtain a point cloud Ps that only contains the roadway four walls and the ground. Because of the need to identify the slope, the interference of the point cloud on the roadway wall needs to be eliminated, and filter the x, y, and z axes of the target slope point cloud by means of straight-through filtering to screen out the slope point cloud with the specified contour of [x1,y1,z1]. At this time, Ps contains a large number of point cloud data, so it is difficult to fit directly and it is easy to make mistakes. Dynamic voxel filtering is chosen to process the slope point cloud, and the change of the surface is judged by the consistency of the normal vector of the point cloud, so as to reduce the voxels where the changes are severe and keep the voxel boundary points to avoid over-sampling and information loss. The point cloud filtering is shown in Formula 1:

$${P}_{g} [ {x}_{ig} , {y}_{ig} , {z}_{ig} ] = {\sum }_{{P}_{j} ∈ {V}_{i}} ( {P}_{j} [ {x}_{ig} , {y}_{ig} , {z}_{ig} ] / ni ) \qquad ( 1 )$$

where p_{g} represents the point cloud after voxel filtering, p; represents the source point cloud, Vi represents the i-th voxel grid, and ni represents the number of point clouds contained in this voxel grid, and all the point clouds in this grid are represented by the center of gravity in each voxel, and dynamic adjustment is carried out on this basis, and the dynamic adjustment process is shown in Formula 2:

$$\{ \begin{matrix}Δ Si = \sum {( np - \overline{n} Si )}^{2} , p ∈ Si \\ if ( Δ Si > {τ}_{1} ) , {Si}^{′} = σ * Si\end{matrix} \qquad ( 2 )$$

where np is the normal vector of each point, ΔSi is the consistency representation of the normal vector, and nSi is the average direction of the normal vector of points inside the voxel Si, np−n̅Si indicating the deviation between a single point and the average direction. If ΔSi exceeds the consistency threshold condition τ₁, the voxel is linearly scaled down according to the ratio r (generally 0.5), and stops when Si′ is less than the minimum voxel side length, and the boundary point set Bnd_{Si} of the original voxel Si is recorded. When Si′ is generated, the points inside Bnd_{Si} are reserved, and finally the filtered ramp point cloud Pᵣₘₚ is output.

A slope detection subunit is used for segmenting and fitting the slope point cloud in the slope point cloud information based on RANSAC random sampling consistency algorithm to obtain the slope information.

In a further embodiment, the specific process of obtaining the slope information by the slope detection subunit is as follows:
acquiring a parameter set to be estimated based on a preset loss function, a threshold constant and an error function of the set distance;
fitting the parameters to be estimated to obtain the optimal parameters, and constructing a slope point cloud fitting model; and
based on the slope point cloud fitting model, the slope information is obtained.

In this embodiment, the collected Lidar point cloud information of the ramp is mainly composed of the ground and the slope, and RANSAC random sampling consistency algorithm may be used to segment and fit the slope point cloud, assuming that the slope point cloud fitting model is expressed as Formula 3:

$${α}_{0} x + {β}_{0} y + {χ}_{0} z + {δ}_{0} = 0 \qquad ( 3 )$$

where α, β, χ and δ are the parameters to be estimated, the initial values of the slope model is estimated first, and then the optimal parameters of the model are obtained by fitting, Pᵣₘₚₘ [α, β, χ, δ], and the way to obtain the parameter set is Formula 4:

$${\hat{P}}_{rmpm} = {arg min}_{{P}_{rmpm}} \{ {\sum }_{D ∈ ramp} Loss ( Err ( D ; M ) ) \} \\ Loss ( e ) = \{ \begin{matrix}0 , - T < e < T \\ σ rp , others\end{matrix} \qquad ( 4 )$$

where ramp is Lidar point cloud, Loss is loss function of calculation model, T is threshold constant, σrp is loss function constant, and Err is error function of set distance. If the ground point cloud simulation fitting is expressed as α₁x+β₁y+χ₁z+δ₁=0, then the included angle of the ramp, namely the slope, may be expressed as Formula 5:

$${θ}_{rmp} = arccos \frac{\vert {α}_{0} {α}_{1} + {β}_{0} {β}_{1} + {χ}_{0} {χ}_{1} \vert}{\sqrt{{α}_{0}^{2} + {β}_{0}^{2} + {χ}_{0}^{2}} + \sqrt{{α}_{1}^{2} + {β}_{1}^{2} + {χ}_{1}^{2}}} + {θ}_{κ} \qquad ( 5 )$$

where θ_{κ} is the error correction variable and θᵣₘₚ is the slope value to be measured, so that the required overall slope information data of the ramp area may be obtained.

A further embodiment is that the IMU data processing unit comprises:
an IMU data acquiring subunit, used for obtaining a pitch angle and a roll angle of the mobile vehicle in a navigation coordinate system based on a three-axis gyroscope and a three-axis accelerometer fixed on the mobile vehicle;
an IMU data processing subunit, used for converting the pitch angle and the roll angle into a directional cosine matrix and establishing an IMU pre-integration observation model; and
a distortion correction subunit, used for carrying out distortion correction on the original point cloud data in the roadway based on the IMU pre-integration observation model, and dividing angular points and surface points by using local smoothness evaluation variables to obtain the initial values of the position and posture of the mobile vehicle.

In this embodiment, the IMU with three-axis gyroscope and three-axis accelerometer is fixed on the mobile vehicle, and the direction of gravity is detected in real time by the accelerometer, and the pitch angle θ_{pitch} and roll angle θᵣₒₗₗ of the mobile platform in the navigation coordinate system w are calculated, and the pitch angle θ_{pitch} and roll angle θᵣₒₗₗ are converted into a direction cosine matrix Cₙ^{b} to represent the rotation relationship from IMU coordinate system to navigation coordinate system. Because the point cloud p_{g} after voxel filtering only contains the point cloud information of the ramp, SLAM mapping should be carried out for the whole roadway, and it is necessary to use the point cloud data Pₛ for secondary processing and use the smoothness evaluation variable c to divide the angular points and surface points; the calculation method of the local smoothness c of the local plane is Formula 6:

$$c = \frac{1}{\vert s \vert \cdot ‖ {X}_{( k , i )}^{L} ‖} \cdot ‖ {\sum }_{j ∈ S , j \neq i} ( {X}_{( k , i )}^{L} - {X}_{( k , j )}^{L} ) ‖ \qquad ( 6 )$$

where s is the number of points in the adjacent point domain, X_{(k,i)}^{L} is the coordinate of point i at time k in Lidar coordinate system, and X_{(k,i)}^{L} is the coordinate of point j at the same time.

The laser point cloud position and posture estimation module, used for classifying feature points based on the slope information and the initial values of the position and posture of the mobile vehicle to obtain a joint error; performing an inter-frame matching position and posture estimation and obtaining key frame factors; and
the high-precision mapping module, used for optimizing a factor map based on the joint error, the inter-frame matching position and posture estimation, the key frame factors and the IMU factors, and obtaining a global map of a ramp based on a local map of the ramp to complete the slope compensation.

A further embodiment is that the laser point cloud position and posture estimation module comprises:
a feature point classification unit, used for comparing the point clouds before and after a straight-through filtering to obtain a slope point cloud, and combining angle information of the pitch angle and the roll angle to classify the feature points;
a joint error construction subunit, used for adding a slope constraint to the mobile vehicle, and obtaining the joint error based on the feature points and joint map optimization of submaps.

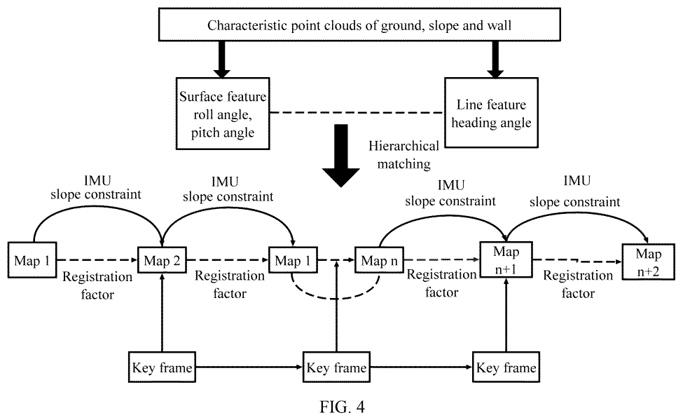

As shown in FIG. 4, in this embodiment, according to the comparison of the point clouds before and after the straight-through filtering, the slope point cloud is obtained, and the feature points are divided into ground points Fa, slope points Fₚ and wall points F_{q} in combination with angle information, and the feature slope points are separated to reduce the error of point cloud matching caused by going up and down the slope, that is, hierarchical matching is carried out by using the surface feature roll angle, pitch angle and line feature heading angle of the feature points. When the mobile robot is going up or down the slope, the slope constraint may be added to reduce the positioning error for the Z-axis displacement of the key frame. Because of the complex condition of the roadway ramp, it is impossible to increase the constraint by constructing the posture map with normal plane driving, so the joint map optimization based on submap is considered. That is, through IMU slope constraint and registration factor, the z-axis displacement of the key frame is reduced to reduce the positioning error. According to the fitted slope parameter set Pᵣₘₚₘ, the slope parameters at the current moment are transformed into the Lidar coordinate system, and the transformation process is shown in Formulas 7 and 8:

$${[ {n}_{α}^{′} , {n}_{β}^{′} , {n}_{χ}^{′} ]}^{T} = {{R}_{t} [ {n}_{α} , {n}_{β} , {n}_{χ} ]}^{T} \qquad ( 7 )$$

$${d}^{′} = d - {{t}_{t} [ {n}_{α}^{′} , {n}_{β}^{′} , {n}_{χ}^{′} ]}^{T} \qquad ( 8 )$$

where n_{α}, n_{β}, n_{γ} are the plane parameters of the ramp, and Rₜ is the rotation of the lidar at time t. tₜ is the translation of the lidar at time t, and d′ represents the distance from the slope to the lidar after translation. At this time, the error between the posture node and the ramp node is eₚₒₛₑ, and at the same time, the angle information of IMU is constructed as an error term and added to the joint map optimization, which is expressed as Formulas 9, 10 and 11:

$${e}_{pose} = p ( {\partial }_{m}^{′} ) - p ( {\partial }_{t} ) \qquad ( 9 )$$

$$p ( \partial ) = [ arctan ( \frac{{n}_{α}}{{n}_{β}} ) , arctan ( \frac{{n}_{χ}}{\vert n \vert} ) , d ] \qquad ( 10 )$$

$$Δ = {e}_{imu} \hat{} T \sum {imu}^{\hat{} - 1} {e}_{pose} \qquad ( 11 )$$

where ∂′m is the slope coordinate in the lidar coordinate system with angle information added, Δis the Mahalanobis distance of the error term, and Σimu^{\hat{ }-1} is the inverse of the covariance matrix of the error term, ∂ is the optimized variable to be estimated after optimization.

The inter-frame matching position and posture estimation subunit, used for performing inter-frame matching position and posture estimation based on the slope information and the initial values of the position and posture of the mobile vehicle to obtain the key frame factors.

In this embodiment, it is assumed that the key frame of the i-th frame of Lidar starts from time tᵢ, the scanning point cloud is Pₛ, the data collected by IMU data in a short time is I_{(i,j)}, the rotation matrix group of the system at time tᵢ is Rᵢ, the speed is vᵢ, the IMU zero offset is bᵢ, and xᵢ is the key frame state. IMU pre-integration may transform high-frequency original observations into constraints between state variables, which provides important prior information for back-end map optimization. The IMU pre-integration observation model is as follows:

$$Δ {\tilde{R}}_{ij} = {R}_{i}^{T} {R}_{j} exp ( δϕ i \hat{j} ) \qquad ( 12 )$$

$$Δ {\tilde{v}}_{ij} = {R}_{i}^{T} ( {v}_{j} - {v}_{i} - g \cdot Δ {t}_{ij} ) + δ {v}_{ij} \qquad ( 13 )$$

$$Δ {\tilde{s}}_{ij} = {R}_{i}^{T} ( {s}_{j} - {s}_{i} - {v}_{i} Δ {t}_{ij} - 0.5 g Δ {t}_{ij}^{2} ) + δ {s}_{ij} \qquad ( 14 )$$

where Δ\tilde{R}ᵢⱼ, Δ\tilde{v}ij and Δ\tilde{s}ij are the rotation, speed and displacement corresponding to the i-j key frame in the time interval t, Rᵢ and Rⱼ represent the rotation matrix of the corresponding frame, vⱼ and vᵢ represent the speed of the corresponding frame, sⱼ and sᵢ represent the displacement of the corresponding frame, the tail term is a random variable, and the joint IMU posture node and environment node error eₚₒₛₑ, δ refers to the deviation of the time integration of the corresponding measured values, and o refers to the exponential mapping of the posture rotation matrix. Adding the minimum constraint of joint error term as shown in Formula 15:

$$min \{ {[ {r}_{Δ {R}_{ij}}^{T} , {r}_{Δ {v}_{ij}}^{T} , {r}_{Δ {f}_{ij}}^{T} ]}^{T} , {e}_{pose} \} \qquad ( 15 )$$

r_{ΔR}_{ᵢⱼ}^{T}, r_{Δv}_{ᵢⱼ}^{T} and r_{Δt}_{ᵢⱼ}^{T}, are the error values between the rotation vector, velocity vector and displacement vector and the actual position and posture transformation. The position and posture estimation of the laser odometer is finally optimized by the factor map, and the map of key frame matching is updated by san-to-map. Specifically, the local map of the ramp is updated, and the factor map is optimized based on key frame factor, IMU factor, minimum constraint of joint error term and map registration, and the local map factor optimized by the factor map and the position and posture estimation of inter-frame matching are registered, and finally the global map is output based on map registration and local map update of the ramp.

### Embodiment 2

The disclosure also provides an implementation method of a laser SLAM system for slope compensation by using IMU, which comprises the following steps:
acquiring and processing original point cloud data in a roadway to obtain slope information; acquiring and processing IMU data of a mobile vehicle to obtain initial values of a position and posture of the mobile vehicle and the IMU factors;
classifying feature points based on the slope information and the initial values of the position and posture of the mobile vehicle to obtain a joint error; performing an inter-frame matching position and posture estimation and obtaining key frame factors; and
optimizing a factor map based on the joint error, the inter-frame matching position and posture estimation, the key frame factors and the IMU factors, and obtaining a global map of a ramp based on a local map of the ramp to complete the slope compensation.

The above-mentioned embodiment is only a description of the preferred mode of the disclosure, and does not limit the scope of the disclosure. Under the premise of not departing from the design spirit of the disclosure, various modifications and improvements made by ordinary technicians in the field to the technical scheme of the disclosure shall fall within the protection scope determined by the claims of the disclosure.

What is claimed is:

1. A laser SLAM system for slope compensation by using IMU, comprising:
a data preprocessing and slope detection module, used for acquiring and processing original point cloud data in a roadway to obtain slope information; acquiring and processing IMU data of a mobile vehicle to obtain initial values of a position and posture of the mobile vehicle and the IMU factors;
a laser point cloud position and posture estimation module, used for classifying feature points based on the slope information and the initial values of the position and posture of the mobile vehicle to obtain a joint error; performing an inter-frame matching position and posture estimation and obtaining key frame factors; and
a high-precision mapping module, used for optimizing a factor map based on the joint error, the inter-frame matching position and posture estimation, the key frame factors and the IMU factors, and obtaining a global map of a ramp based on a local map of the ramp to complete the slope compensation.

2. The laser SLAM system for slope compensation by using IMU according to claim 1, wherein the data preprocessing and slope detection module comprises:
a point cloud data processing unit, used for acquiring the original point cloud data in the roadway and filtering the original point cloud data to obtain point cloud information of the ramp;
segmenting and fitting the point cloud information of the ramp by adopting a random sampling consistent algorithm to obtain the slope information; and
an IMU data processing unit, used for acquiring the IMU data of the mobile vehicle, and performing IMU pre-integration based on the point cloud information of the ramp to obtain the initial values of the position and posture of the mobile vehicle.

3. The laser SLAM system for slope compensation by using IMU according to claim 2, wherein the point cloud data processing unit comprises:
a point cloud data acquiring subunit, used for acquiring the original point cloud data in the roadway;
a filtering subunit, used for filtering out outliers in the original point cloud data in the roadway based on a statistical filter to obtain point clouds only comprising roadway four walls and ground; based on a straight-through filter, point cloud of the roadway four walls in the point cloud comprising the roadway four walls and the ground are filtered to obtain a slope point cloud with a preset contour; filtering the slope point cloud based on a dynamic voxel filter to obtain the point cloud information of the ramp; wherein the point cloud information of the ramp comprises ground point clouds and slope point clouds; and
a slope detection subunit, used for segmenting and fitting the slope point cloud in the slope point cloud information based on RANSAC random sampling consistency algorithm to obtain the slope information.

4. The laser SLAM system for slope compensation by using IMU according to claim 3, wherein a specific process for the slope detection subunit to obtain the slope information is as follows:
acquiring a parameter set to be estimated based on a preset loss function, a threshold constant and an error function of a set distance;
fitting the parameter set to be estimated to obtain optimal parameters, and constructing a slope point cloud fitting model; and
obtaining the slope information based on the slope point cloud fitting model.

5. The laser SLAM system for slope compensation by using IMU according to claim 3, wherein the IMU data processing unit comprises:
an IMU data acquiring subunit, used for obtaining a pitch angle and a roll angle of the mobile vehicle in a navigation coordinate system based on a three-axis gyroscope and a three-axis accelerometer fixed on the mobile vehicle;
an IMU data processing subunit, used for converting the pitch angle and the roll angle into a directional cosine matrix and establishing an IMU pre-integration observation model; and
a distortion correction subunit, used for carrying out distortion correction on the original point cloud data in the roadway based on the IMU pre-integration observation model, and dividing angular points and surface points by using local smoothness evaluation variables to obtain the initial values of the position and posture of the mobile vehicle.

6. The laser SLAM system for slope compensation by using IMU according to claim 1, wherein the laser point cloud position and posture estimation module comprises:
a feature point classification unit, used for comparing the point clouds before and after a straight-through filtering to obtain a slope point cloud, and combining angle information of a pitch angle and a roll angle to classify the feature points;
a joint error construction subunit, used for adding a slope constraint to the mobile vehicle, and obtaining the joint error based on the feature points and joint map optimization of submaps; and
an inter-frame matching position and posture estimation subunit, used for performing inter-frame matching position and posture estimation based on the slope information and the initial values of the position and posture of the mobile vehicle to obtain the key frame factors.

7. The laser SLAM system for slope compensation by using IMU according to claim 6, wherein the feature points comprise ground points, slope points and wall points.

8. An implementation method of a laser SLAM system for slope compensation by using IMU, comprising following steps:
acquiring and processing original point cloud data in a roadway to obtain slope information;
acquiring and processing IMU data of a mobile vehicle to obtain initial values of a position and posture of the mobile vehicle and the IMU factors;
classifying feature points based on the slope information and the initial values of the position and posture of the mobile vehicle to obtain a joint error; performing an inter-frame matching position and posture estimation and obtaining key frame factors; and
optimizing a factor map based on the joint error, the inter-frame matching position and posture estimation, the key frame factors and the IMU factors, and obtaining a global map of a ramp based on a local map of the ramp to complete the slope compensation.
